(19) United States
(12) Patent Application Publication
(10) Pub. No.: US 2014/0262008 A1
(43) Pub. Date: Sep. 18, 2014

(54) HEATED ROLLER HEAD BONDING PROCESS

(71) Applicant: Apple Inc., Cupertino, CA (US)

(72) Inventors: Santhana Krishnan BALAJI, Cupertino, CA (US); Sui-Lun WONG, Hong Kong (HK); Andrew D. LAUDER, Oxford (GB)

(21) Appl. No.: 13/888,302

(22) Filed: May 6, 2013

Related U.S. Application Data
(60) Provisional application No. 61/792,857, filed on Mar. 15, 2013.

(51) Int. Cl. B32B 37/10; B32B 37/06

(52) U.S. Cl. CPC B32B 37/10; B32B 37/06
USPC 156/272.2; 156/60; 156/582; 156/378; 156/379.6

(57) ABSTRACT

A laminating device for bonding a protective layer to a substrate, including a driver and a roller head having a shape with a contour to fit a geometric feature of the substrate, is provided. The roller head has a cylindrical symmetry with an axis; the laminating device includes a coupler for mechanically coupling the driver to the roller head. The coupler is parallel to the axis so that the driver provides a rotational motion and a liner displacement to the roller head. The driver also provides a bonding energy to the roller head through the coupler. A roller head for use in a laminating device as above is also provided. A method for bonding a protective layer to a substrate using a laminating device as above is also provided.

### CROSS REFERENCE TO RELATED APPLICATIONS

The present application claims the benefit under 35 U.S.C. 119(e) of U.S. Prov. Pat. Appl. No. 61/792,857, entitled “HEATED ROLLER HEAD BONDING PROCESS,” by Santhana Krishnan BALAJI, et al. filed on Mar. 15, 2013, the contents of which are hereby incorporated herein by reference, in their entirety, for all purposes.

The present disclosure is related to U.S. patent application Ser. No. 13/865,096, entitled “COMPLIANT PERMEABLE GLUE APPLICATOR,” by Santhana K. Balaji, and Benjamin M. Rappoport, filed Apr. 17, 2013, under Attorney Docket No. P17644US1/16840US.1, the contents of which are hereby incorporated by reference in their entirety, for all purposes.

### FIELD OF THE DESCRIBED EMBODIMENTS

The described embodiments relate generally to methods, devices, and systems for bonding a protective layer on a substrate having a complex profile. More particularly, embodiments in the present disclosure relate to bonding a fabric to a rigid shell for assembling a protective casing for an electronic device.

### BACKGROUND

In the field of bonding protective layers to rigid substrates having a complex geometry, it is desired to avoid wrinkles and weak bonding spots. An improper bonding typically results in non-compliant adhesion of the protective layer applied on the rigid substrate, forming gaps, bubbles, wrinkles, dangling edges, and detachment points. In addition to the aesthetically unpleasant result, a non-compliant adhesion deteriorates progressively until a functional value of the resulting structure is seriously affected. For example, when the bonded layers are part of a casing for a handheld or portable electronic device, protective layers in the casing may become loose, impairing the ability to properly close or open the casing, or the ability to maintain a desired ergonomic configuration. This problem is exacerbated in portions of the casing having a complex geometry, where a protective layer desirably complies with an acute feature of the rigid substrate.

Some attempts at solving bonding uniformity problems include the use of a roller applicator to apply pressure between a protective layer and a hard substrate, to cure adhesive layer. However, while rolling works well for flat substrates, rolling applicators are difficult to use on substrates having complex geometries, due to the rigidity and geometric constraints of the rolling applicators used. In some approaches, a heat press is used to provide a bonding energy to the adhesive layer and apply a uniform pressure to the substrate. However, since the heat press covers an extended area, the energy provided is not localized and thus areas having a complex geometry may not be properly laminated. Moreover, using a heat press the adhesive layer may not be fully solidified when the tool is released, which causes a protective layer to pull away from the substrate in areas where the complex substrate geometry creates tension in the protective layer (such as a sharp edge in a lip undercut).

Therefore, what is desired is a method and a system for bonding a protective layer on a substrate having a complex profile that provides a uniform and seamless layered structure. What is also needed is a method and a system for securely and seamlessly bonding a protective layer on a substrate having a complex geometry.

### SUMMARY OF THE DESCRIBED EMBODIMENTS

According to some embodiments, a laminating device for bonding a protective layer to a substrate, may include a driver and a roller head having a shape with a contour to fit a geometric feature of the substrate. The roller head may have a cylindrical symmetry with an axis; the laminating device including a coupler for mechanically coupling the driver to the roller head. In some embodiments, the coupler is substantially parallel to the axis so that the driver provides a rotational motion and a liner displacement to the roller head through the coupler. The driver also provides a bonding energy to the roller head through the coupler.

Further according to some embodiments a roller head for use in a laminating device to bond a protective layer to a substrate may include a body having a compliant contour to fit a substrate feature. The body may be adapted to transmit a bonding energy to an adhesive layer on a top surface of the substrate at a localized contact point. The transmitting of a bonding energy occurs at a pre-selected temperature, and pressure, and for a pre-selected dwell time.

In some embodiments disclosed herein a method for bonding a protective layer to a substrate may include placing a protective layer over a substrate, the substrate having a top surface covered with an adhesive layer. The method may also include rotating a roller head and placing the rotating roller head proximal to the protective layer and providing a bonding energy to an adhesive layer on the substrate through the protective layer. Further, the method may include displacing the roller head along a trajectory in a top surface of the substrate, to form a seamless and securely bonded laminated structure.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments may be better understood by reference to the following description and the accompanying drawings. Additionally, advantages of the described embodiments may be better understood by reference to the following description and accompanying drawings. These drawings do not limit any changes in form and detail that may be made to the described embodiments. Any such changes do not depart from the spirit and scope of the described embodiments.

FIG. 1 illustrates a lamination device according to some embodiments.

FIG. 2 illustrates a lamination device bonding a protective layer on a substrate, according to some embodiments.

FIG. 3A illustrates a cross-sectional partial view of a casing structure including a protective layer and a substrate, manufactured according to some embodiments.

FIG. 3B illustrates a cross-sectional partial view of an engagement between an electronic device and a casing structure including a protective layer and a substrate, manufactured according to some embodiments.

FIG. 4A illustrates a lamination device according to some embodiments.

FIG. 4B illustrates a lamination device according to some embodiments.

FIG. 5A illustrates a lamination device according to some embodiments.

FIG. 5B illustrates a lamination device according to some embodiments.

FIG. 5C illustrates a lamination device according to some embodiments.

FIG. 6 illustrates a lamination device according to some embodiments.

FIG. 7 illustrates a lamination device according to some embodiments.

FIG. 8 illustrates a lamination device according to some embodiments.

FIG. 9 illustrates a lamination device according to some embodiments.

FIG. 10 illustrates a flow chart including steps in a method for lamination of a substrate to form a casing, according to some embodiments.

In the figures, elements referred to with the same or similar reference numerals include the same or similar structure, use, or procedure, as described in the first instance of occurrence of the reference numeral.

### DETAILED DESCRIPTION OF SELECTED EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

In the field of portable electronic devices, such as handheld phones, tablets, and other computational appliances, the casing structure is a highly relevant feature. Electronic devices including casings manufactured using devices and methods as described herein may include cellular phones, notepads, laptops and similar devices. Casing structures for handheld electronic devices provide protection to the electronic circuitry inside, including delicate sensor transducers. Casing structures for handheld electronic devices desirably provide a rugged and pleasant platform for device display use while the user is moving, or in any other informal circumstance. Thus, the integrity, reliability, and aesthetic quality of the casing structure is important, especially for advancing a product in an extremely competitive market. To this effect, it is desirable to have device structures that are reliably assembled, thus appropriately bonding a fabric layer on a hard shell for a casing.

Casings for electronic devices according to embodiments disclosed herein include a protective layer bonded to a substrate. The protective layer may be a flexible material, and the substrate may be a rigid shell. For example, the protective layer may be a woven material such as a fabric or a micro-fabric, or it may be a non-woven material such as a rubber membrane, or any other layer that provides physical protection to the electronic device. Examples of protective layers that may be used in embodiments consistent with the present disclosure include woven materials such as fabrics, fabric laminates, knit fabrics, and microfibers. In some embodiments, a protective layer including non-woven materials such as microfibers and felt may be included.

FIG. 1 illustrates a lamination device 100 according to some embodiments. Lamination device 100 includes a roller head 101, a coupler 111, and a driver 170 providing a rotation to the roller head through coupler 111. Driver 170 may include a processor circuit 171 and a memory circuit 172 to control the rotation of roller head 101. In some embodiments, driver 170 may also include a sensor system 175 to control the rotation and movement of roller head 101. Sensor system 175 may include a pressure sensor, a temperature sensor, and a contact sensor. In some embodiments a contact sensor may include an electric circuit such as a capacitive circuit, an optical sensor, and a video camera. Signals provided by sensor system 175 may be processed in processor circuit 171 and stored in memory circuit 172. Processor 171 may provide a controlling signal to rotate head 101 based on a signal received from sensor system 175. For example, when a signal from sensor system 175 shows a high contact force between roller head 101 and substrate 150, processor circuit 171 may provide commands to roller head 101 to slightly move in a direction away from top surface 151. Thus, a contact force may be reduced to a desired value, as measured by a sensor in sensor system 175. Accordingly, in some embodiments the rotation of applicator head 101 is adjusted relative to the displacement of axis ‘A’ so as to avoid slippage between a contact area between applicator head 101 and top surface 151.

In FIG. 1, coupler 111 provides mechanical support and a rotational motion to roller head 101. Accordingly, roller head 101 may have a cylindrical symmetry about an axis ‘A,’ parallel to coupler 111. Driver 170 may include a motor that provides a rotation to coupler 111 and to roller head 101. Furthermore, driver 170 may also provide a linear displacement to coupler 111. FIG. 1 also illustrates protective layer 125 bonded to a top surface 151 of a substrate 150, as roller head 101 provides a bonding energy through a contact point. Thus, the bonding energy provided by roller head 101 is localized within a contact area between roller head 101 and protective layer 125. The bonding energy may include a pressure and a heat transferred to an adhesive layer 110 sandwiched between protective layer 125 and substrate 150. Adhesive layer 110 may include a thermoplastic adhesive that is activated at a certain temperature, such as 120° C., 140° C., or any other temperature. A thermoplastic adhesive may reflow after curing, when it reaches the activation temperature. In some embodiments, adhesive layer 110 may include a thermosetting adhesive. A thermosetting adhesive has no reflow even when it reaches the activation temperature after curing. Substrate 150 includes a lip 130 and a sharp corner 135 joining lip 130 to a sidewall of substrate 150. In some embodiments, roller head 101 includes a body having a compliant contour to fit a substrate feature. A substrate feature may include lip 130 and sharp corner 135. For example, the body of roller head 130 may be made of a foam or a rubber material that deforms and complies with the sharp protrusion of the lip and presses against the sharp corner. In some embodiments, roller head may be formed of a hard material such as a metal, and have a shape with a contour to fit a substrate feature.

FIG. 2 illustrates lamination device 100 bonding a protective layer 225 on a substrate 250, according to some embodiments. Substrate 250 includes a lip 230 having a sharp corner 235. According to some embodiments, driver 170 controls lamination device 100 to form a trajectory 205 over protective layer 225, covering top surface 251 of substrate 250. Trajectory 205 is formed by displacing coupler 111 at a speed ‘v,’ as illustrated in FIG. 2. Accordingly, the speed ‘v’ of linear displacement may be selected so that no relative displacement occurs between the surface of roller head 101 and top surface 251 at a contact point, as the roller head rotates at rotational speed ‘ω.’ For example, in some embodiments roller head 101 softly rolls along a sidewall portion of top surface 251 including a portion of lip 230, and sharp corner 235. In some embodiments, lamination device 100 may be mounted to a computer numerical control (CNC) router. In such configuration, the CNC router rotates and displaces roller head 101 along trajectory 205 on top surface 251, smoothly applying a localized bonding energy to adhesive layer 210 in a single pass.

In embodiments consistent with the present disclosure, lamination device 100 is able to localize the bonding energy transmitted to adhesive layer 210 in a selected area. The bonding energy may include a temperature and a pressure for activation of adhesive layer 110 at a contact point between roller head 101 and protective layer 125. The temperature of a localized area of adhesive layer 210 may be controlled by driver 170 setting roller head 101 at a given temperature, measured by sensor system 175. A pressure provided to a localized area of adhesive layer 210 may be controlled by driver 170 providing a desired contact force, measured by sensor system 175. The localized bonding energy may also include a dwell time during which roller head 101 is in contact with a localized area of adhesive layer 210. Accordingly, a dwell time ‘dt’ may be determined by selecting the rotational speed ‘ω’ and the linear displacement speed ‘v’ of roller head 101. In that regard, in some embodiments it is desirable that ‘dt’ be long enough to allow adhesive layer 210 to re-solidify while roller head 101 is still in contact with a complex feature such as lip 230 and sharp corner 235. For example, after providing a bonding energy at a contact point Pt along trajectory 205 at time t, roller head 101 may move slightly away at a time t′=t+dt, to a contact point Pt′. Point Pt′ may be far enough from point Pt such that a bonding energy provided by roller head 101 does not cause adhesive layer 210 to reflow or be damaged at point Pt. Likewise, point Pt′ may be close enough to point Pt such that protective layer 225 remains pressed against substrate 250 at point Pt by the pressure at point Pt′. Thus, the rate of adhesive activation may be controlled for different points along trajectory 205 by controlling the motion and speed of roller head 101, using driver 170. The rotational speed ‘ω’ and the linear speed ‘v’ of roller head 101 may be reduced in areas where a strong bond is desired. Likewise, the rotational speed ‘ω’ and the linear speed ‘v’ of roller head 101 may be increased in areas that are sensitive to heat. For example, ‘ω’ and ‘v’ may be reduced along points of trajectory 205 near corner point 280, and slightly increased away from corner point 280. Further ‘ω’ and ‘v’ may be increased in flat areas away from contact with lip 230 and sharp corner 235.

FIG. 3A illustrates a cross-sectional partial view of a casing structure 300 including a protective layer 125 and a substrate 350, manufactured according to some embodiments. Casing structure 300 includes an adhesive layer 110 disposed between protective layer 125 and casing structure 300. Also shown in FIG. 3A is lip 130 and sharp corner 135. In embodiments consistent with the present disclosure, protective layer 125 closely follows the profile of substrate 150 in casing structure 300, including sharp corner 135. Thus, no bubbling or gap of protective layer 125 forms in sharp corner 135, according to some lamination methods disclosed herein.

FIG. 3B illustrates a cross-sectional partial view of an engagement between an electronic device 355 and casing structure 300 including protective layer 125 and substrate 150, manufactured according to some embodiments. Electronic device 355 may include cellular phones, tablets, laptops and other computational appliances. According to some embodiments, electronic device 355 may include a chamfer 360 forming an angle 361 with the top surface of electronic device 355. Chamfer 360 is such that engages lip 130 of casing structure 300 at an undercut 370. Undercut 370 forms an angle 371 with the top surface of electronic device 355. Accordingly, angle 371 may be shallower than angle 361. In some embodiments angle 361 may be about 45° while angle 361 may be about 30°. This enables electronic device 355 to be engaged by casing structure 300 at contact points 340 and 341, thus providing a positive and comfortable feel for the user of electronic device 355. In embodiments consistent with the present disclosure electronic device 355 snap fits within casing structure 300, similar to a clip action. Accordingly, contact points 340 and 341 allow electronic device 355 to snap in place. This provides a feel of a positive engagement between electronic device 355 and casing structure 300. Thus, it is desirable that cover layer 125 follows closely the contour of substrate 150.

Casing structure 300 is as described in detail above in reference to FIG. 3A. Accordingly, protective layer 125 is laminated over top surface 151 following closely he features in substrate 150, such as sharp corner 135, and lip 130. In embodiments consistent with the present disclosure protective layer 125 is adhesively bonded to top surface 151, leaving no gap, bubble, nor dangling portion on sharp corner 135. Thus, protective layer 125 provides cover to top surface 151, an aesthetically pleasing view without interfering with the performance of casing structure 300.

FIG. 4A illustrates a lamination device 400A according to some embodiments. Lamination device 400A includes roller head 401A adapted for high frequency activation of adhesive 410. In some embodiments, the adhesive may have a polarity that enables the adhesive to absorb electro-magnetic energy in the radio-frequency (RF) energy spectrum. When an RF absorbing adhesive is used, RF energy may be used to heat an adhesive layer 410 and activate the adhesive in a precisely controlled area. In some embodiments, the RF absorbing adhesive used in adhesive layer 410 may be a thermosetting adhesive or a thermoplastic adhesive. Accordingly, driver 170 may include an RF source 477 generating an alternate current (AC) 480 flowing through roller head 401A. By coupling substrate 150 to ground 478, AC 480 flows through adhesive layer 410, providing the RF energy to activate the adhesive. Ground 478 is also coupled to the ground in RF source 477, to close the RF circuitry. Accordingly, only portions of adhesive layer 410 included in the circuit between RF source 477 and ground 478 are activated. In some embodiments, only the portions of adhesive layer 410 in a contact area of roller head 401A and substrate 150 are activated. Accordingly, lamination device 400A provides a controlled lamination process for protective layer 125. Lamination device 400A avoids reflow of adhesive from adhesive layer 410 in portions of the roller trajectory behind the position of roller head 400A (e.g., trajectory 205, cf. FIG. 2).

In embodiments consistent with the present disclosure, substrate 150 may be formed of an electrically conductive material, such as an aluminum shell. In some embodiments, substrate 150 may be coated with an electrically conductive material, such as aluminum. Accordingly, roller head 401A in lamination device 400A may be formed of an electrically conductive material, such as a metal. In some embodiments, roller head 401A may be formed of any material having an exterior surface coated with an electrically conductive layer of material or paint. Moreover, in some embodiments lamination device 400A may be formed of a compliant material that is also conductive, such as a conductive foam, as described in detail below with reference to FIG. 4B.

FIG. 4B illustrates a lamination device 400B according to some embodiments. Lamination device 400B may be as lamination device 400A, described in detail above. In some embodiments, lamination device 400B includes roller head 401B made of a conductive foam. Roller head 401B provides AC current 480 to adhesive layer 410. Conductive foam 401B includes pores 421, having a diameter. Pores 421 provide a resilience so that roller head 401B may adapt to complex geometrical features in substrate 150 such as lip 135 and sharp corner 130. Thus, roller head 401B may have a generic shape that adapts to different geometries encountered in substrate 150. Even when roller head 401B has a cylindrical shape with a radius larger than the radius of curvature of a feature in substrate 150, compliant foams may deform accordingly, securely and evenly applying pressure to top surface 151, through protective layer 125, and adhesive layer 410. One of ordinary skill will recognize that the material forming roller head 401B is not limited to a foam. More generally, roller head 401B may be formed of an electrically conductive material having a resilience. In that regard, a resilient material has flexibility to adapt and comply with a profile when in contact with a hard substrate, providing a pressure force against the substrate. When the resilient material is removed from contact with the hard substrate, it recovers its original shape and volume. Examples of compliant materials in some embodiments may include rubbers, silicones, and foams.

FIG. 5A illustrates a lamination device 500A according to some embodiments. Lamination device 500A includes roller head 501A adapted for heat activation of adhesive layer 110. In some embodiments, roller head 501A may be used to heat adhesive layer 110 and activate the adhesive in a precisely controlled area. Accordingly, driver 170 may include a heat source 577 generating a heat flow 580 through roller head 501A. Thus, only portions of adhesive layer 110 where protective layer 125 contacts roller head 501A are activated. Accordingly, lamination device 500A provides a controlled lamination process for protective layer 125. Lamination device 500A avoids reflow of adhesive from adhesive layer 510 in portions of the roller trajectory behind the position of roller head 500A (e.g., trajectory 205, cf. FIG. 2).

FIG. 5B illustrates a lamination device 500B according to some embodiments. Lamination device 500B may be as lamination device 500A, described in detail above. In some embodiments, lamination device 500B includes roller head 501B made of a heat conducting foam. Roller head 501B provides heat flow 580 to adhesive layer 110. Heat conductive foam 501B includes pores 521, having a diameter. Pores 521 also provide a resilience so that roller head 501B may adapt to complex geometrical features in substrate 150 such as lip 135 and sharp corner 130. Thus, roller head 501B may have a generic shape that adapts to different geometries encountered in substrate 150. One of ordinary skill will recognize that the material forming roller head 501B is not limited to a foam. More generally, roller head 501B may be formed of a heat conductive material having a resilience. In that regard, in some embodiments roller head 501B includes a foam having a porous matrix such that a fluid at a fluid temperature may fill roller head 501B, heating adhesive layer 110 through a contact area between rolling head 501B and protective layer 125. The fluid temperature may be desirable hot, to enable adhesive bonding, according to some embodiments. In some embodiments, heater 577 may provide a fluid at an elevated temperature, generating heat flow 580 in a porous matrix forming roller head 501B. In some embodiments, electrically and thermally conductive materials and foams may be used to form head 501B. Some embodiments may include conductive gels and conductive silicones.

FIG. 5C illustrates a lamination device 500C according to some embodiments. Lamination device 500C may be as lamination devices 500A and 500B described in detail above. In some embodiments, lamination device 500C includes roller head 501C made of an impermeable and resilient membrane 525 filled with a hot fluid 535. Membrane 525 may include a heat conducting material, or may have a reduced thickness such that heat may transfer efficiently from the interior of roller head 501C to adhesive layer 110 across membrane 525. Roller head 501C provides heat flow 580 to adhesive layer 110. Membrane 525 provides resilience so that roller head 501C adapts to complex geometrical features in substrate 150 such as lip 135 and sharp corner 130. Thus, roller head 501C may have a generic shape that adapts to different geometries encountered in substrate 150. One of ordinary skill will recognize that the material forming roller head 501C may be a rubber, or similar material. More generally, membrane 525 may be formed of a heat conductive material having a resilience. In some embodiments, membrane 525 may include materials such as silicones, natural and synthetic rubbers, polyurethane, and combinations thereof. The specific amounts of the component materials for membrane 525 may be varied to achieve a desirable compliance. A desirable compliance may depend on the hardness of the substrate used, the viscosity of the adhesive layer, and the resilience of the protective layer. Membrane 525 may include a flexible membrane, according to some embodiments.

Heater 577 in lamination devices 500A, 500B, and 500C may include an electric circuit that generates heat flow 580 upon a current flow through an electrically resistor. In some embodiments, heater 577 may also provide a hot fluid as a heat source. Accordingly, in embodiments consistent with the present disclosure roller head 501A, 501B, or 501C may be formed of a material having a high thermal conductivity, such as a metal. For example, in some embodiments, roller head 501A, 501B, or 501C may include an amount of copper, aluminum, or tin. The body inside roller head 501A may include a conduit to transport the hot fluid and provide the heat flow. The porous matrix in roller head 501B may be soaked in the hot fluid. In some embodiments the hot fluid may be a fluid at 120° C. or 140° C., or any other temperature at or slightly above an activation temperature for the adhesive in adhesive layer 110.

FIG. 6 illustrates a lamination device 600 according to some embodiments. Lamination device 600 includes driver 170, coupler 111, and roller head 601. Driver 170 may include processor circuit 171, memory circuit 172, and sensor system 175. Roller head 601 is used to adhesively bond protective layer 125 to substrate 150 through adhesive layer 110. In that regard, driver 170, sensor system 175, processor circuit 171, memory circuit 172, protective layer 125, adhesive layer 110, and substrate 150 may be as described in detail above (cf. FIG. 1).

In some embodiments, roller head 601 contacts protective layer 125 activating adhesive layer 110 in a portion of top surface 151 including a complex geometric feature, such as lip 130 and sharp corner 135. In that regard, roller head 601 may have a geometry and shape forming a gap 605 with a flat portion of top surface 151. Gap 605 allows a portion of protective layer 125 previously bonded to a flat portion of top surface 151 to remain undisturbed while a portion of protective layer 125 is adhesively bonded to lip 130 and sharp corner 135. Accordingly, driver 170 may provide pre-selected control commands to roller head 601 so that the rotational speed ‘ω’ and the linear speed ‘v’ are sufficiently low to adhesively bond protective layer 125 to lip 130 and sharp corner 135. For example, in some embodiments roller head 601 may rotate at a lower speed when in contact with lip 130 and sharp corner 135, to ensure proper curing of adhesive layer 110 between protective layer 125 and top surface 151.

FIG. 7 illustrates a lamination device 100 according to some embodiments. Lamination device 100 includes driver 170, coupler 111, and roller head 101. Driver 170 includes processor circuit 171, memory circuit 172, and sensor system 175. Accordingly, coupler 111, and roller head 101 may be as described in detail above (cf. FIG. 1). Roller head 101 rotates about symmetry axis A and is displaced about a top surface 751 of a substrate 750, curing adhesive layer 110 and bonding a protective layer 725 to top surface 751. In some embodiments, the geometry and shape of rolling head 101 and substrate 750 may be such that a single pass along each of the sides of substrate 150 completes the lamination of protective layer 725 over top substrate 751.

FIG. 8 illustrates a lamination device 800 according to some embodiments. Lamination device 800 includes driver 170, coupler 111, and roller head 801. Driver 170 includes processor circuit 171, memory circuit 172, and sensor system 175. Accordingly, coupler 111, and roller head 101 may be as described in detail above (cf. FIG. 1). Roller head 801 is used to adhesively bond protective layer 125 to substrate 150 through adhesive layer 110. In that regard, driver 170, sensor system 175, processor circuit 171, memory circuit 172, protective layer 125, adhesive layer 110, and substrate 150 may be as described in detail above (cf. FIG. 1).

Roller head 801 may include heating elements 810, 811, and 812, distributed through a cross section of roller head 801 along axis A. Accordingly, a first heating element 810 may be proximal to lip 130 and to sharp corner 135 in substrate 150. A second heating element 811 may be proximal to a sidewall in substrate 150, and a third heating element 812 may be proximal to a flat portion in substrate 150. In some embodiments, heating elements 810, 811, and 812 may include a plurality of conduits providing a localized bonding energy to adhesive layer 110. For example, the conduits in heating elements 810, 811, and 812 may include a hot fluid. In some embodiments, heating elements 810, 811, and 812 may include coiled conductors having an electrical resistivity so that heat is generated as current flows through them. Thus, heating element 810 may include a first heater carrying a first electrical current, heating element 811 may include a second heater carrying a second electrical current. And heating element 812 may include a third heater carrying a third electrical current. By separately controlling the amount of heat generated, heating element 810 reaches a first temperature, heating element 811 reaches a second temperature, and heating element 812 reaches a third temperature. Thus, roller head 801 provides a localized bonding energy to protective layer 125. For example, roller head 801 may provide sufficient heat to cure adhesive layer 110 proximal to lip 130 and sharp corner 135, avoiding a reflow of adhesive from portions of adhesive layer 110 in areas not proximal to lip 130 and sharp corner 135.

FIG. 9 illustrates a lamination device 900 according to some embodiments. Lamination device 900 includes driver 170, coupler 111, and roller head 901. Driver 170 may include processor circuit 171, memory circuit 172, and sensor system 175. Roller head 901 is used to adhesively bond protective layer 125 to substrate 150 through adhesive layer 110. In that regard, Driver 170, sensor system 175, processor circuit 171, memory circuit 172, protective layer 125, adhesive layer 110, and substrate 150 may be as described in detail above (cf. FIG. 1). Roller head 901 includes a top portion 902 and a bottom portion 903, mechanically coupled through couplers 905. Couplers 905 provide a gap or separation D between top portion 902 and bottom portion 903, along axis A. Thus, a contact force between roller head 901 and substrate 150 may be regulated accordingly. For example, by increasing gap D, a contact force between roller head 901 and substrate 150 may be increased. Likewise, by reducing gap D, a contact force between roller head 901 and substrate 150 may be reduced. Controlling couplers 905 to select a gap D may be provided by processor circuit 171 upon receiving information regarding the contact force between roller head 901 and substrate 150 from sensor system 175. In some embodiments, couplers 905 may be electromagnetically actuated couplers, or hydraulically actuated couplers.

FIG. 10 illustrates a flow chart including steps in a method 1000 for lamination of a substrate to form a casing, according to some embodiments. Method 1000 may be performed using a lamination device such as disclosed herein (e.g., lamination devices 100, 400A, 400B, 500A, 500B, 600, 800, and 900, cf. FIGS. 1, 4A, 4B, 5A, 5B, 6, 8, and 9). The lamination device may use a driver including a sensor system, a processor circuit, and a memory circuit (e.g., driver 170, processor circuit 171, memory circuit 172, and sensor system 175, cf. FIG. 1). The lamination device may include a roller head and a coupler coupling the driver to the roller head (e.g., roller head 101 and coupler 111, cf. FIG. 1). Method 1000 may be used to adhesively bond a protective layer on a top surface of a substrate through an adhesive layer (e.g., protective layer 125, top surface 151, substrate 150, and adhesive layer 110, cf. FIG. 1).

Step 1010 includes placing a protective layer over a substrate. Accordingly, the substrate may have a top surface covered with an adhesive layer. In that regard, in some embodiments step 1010 may include forming an adhesive layer over a top surface of the substrate. Step 1010 may include placing a soft piece of cloth, or a woven material including a fabric or a micro-fabric, on a top surface of a substrate. In some embodiments, step 1010 may include placing a non-woven material over the substrate. A non-woven material may include a membrane made of rubber or similar material. The top surface may include an adhesive layer previously placed on the substrate, with a desired thickness. In some embodiments step 1010 may include placing the adhesive layer with a desired thickness on the substrate.

Step 1020 includes rotating a roller head at a pre-selected rotational speed. Accordingly, in some embodiments step 1020 may include rotating a coupler mechanically coupled to the roller head and a driver. In some embodiments the coupler is aligned with a symmetry axis of the roller head (e.g., axis ‘A’ in roller head 101, cf. FIG. 1). Thus, step 1020 may include rotating the roller head about its symmetry axis.

Step 1030 includes placing the roller head proximal to a protective layer on a substrate. In some embodiments, step 1030 includes providing a contact force from the roller head to the substrate, through the protective layer and the adhesive layer. Accordingly, step 1030 may include measuring the contact force between the roller head and the substrate. Step 1030 may include using a sensor system included in the roller head driver, to provide a contact force measurement.

Step 1040 includes allowing the roller head to deform in compliance with the substrate profile. The substrate profile may include a lip and a sharp corner (e.g., lip 130 and sharp corner 135, cf. FIG. 1). In some embodiments, step 1040 may include moving the roller head relative to the substrate in order to adjust the contact force at a pre-selected value. Accordingly, in some embodiments step 1040 may include moving the roller head away from the substrate when a contact force measured in step 1030 is above a high threshold value. Likewise, step 1040 may include moving the roller head closer to the substrate when a contact force measured in step 1030 is below a low threshold value.

Step 1050 includes providing a bonding energy to the adhesive layer. In some embodiments, step 1050 includes heating the adhesive layer. For example, heating the adhesive layer may be desirable when the adhesive layer includes a thermosetting or a thermoplastic adhesive material. In some embodiments, step 1050 may include providing an RF energy to the adhesive layer. Accordingly, step 1050 may include using an RF source coupled to the roller head. Step 1050 may also include coupling the substrate to a ground coupled to the RF source (e.g., RF source 477 and ground 487, cf. FIGS. 4A and 4B).

Step 1060 includes displacing the roller head along a trajectory on the top surface of the substrate (e.g., trajectory 205, cf. FIG. 2). Accordingly, step 1060 may include displacing the roller head such that there is no relative displacement between the surface of the roller head and a top surface in the substrate at a contact point, as the roller head rotates. For example, in some embodiments step 1060 includes allowing the roller head to softly roll along a sidewall or a geometric feature in the top surface of the substrate. The geometric surface may be a lip or similar protuberance in the top surface of the substrate (e.g., lip 135, cf. FIG. 1). Thus, steps in method 1000 result in a seamless and securely bonded laminated structure for a casing of an electronic device.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A laminating device for bonding a protective layer to a substrate, comprising:
a driver;
a roller head having a shape with a contour to fit a geometric feature of the substrate, the shape having a cylindrical symmetry with an axis; and
a coupler for mechanically coupling the driver to the roller head, the coupler being substantially parallel to the axis; wherein
the driver provides a rotational motion and a linear displacement to the roller head through the coupler; and
the driver provides a bonding energy to the roller head through the coupler.

2. The laminating device of claim 1 wherein the roller head comprises a compliant foam.

3. The laminating device of claim 1 wherein the roller head comprises an electrically conductive material.

4. The laminating device of claim 1 wherein the roller head comprises a thermally conductive material.

5. The laminating device of claim 1 wherein the roller head comprises a plurality of conduits adapted to provide the bonding energy.

6. The laminating device of claim 5 wherein the plurality of conduits comprises a first fluid conduit to provide fluid at a first temperature and a second fluid conduit to provide fluid at a second temperature.

7. The laminating device of claim 5 wherein the plurality of conduits comprises a first electrical resistor to provide heat upon a flow of a first electrical current; and
a second electrical resistor to provide heat upon a flow of a second electrical current.

8. The laminating device of claim 1 wherein
the roller head comprises a membrane filled with a fluid; and
the driver provides a heat to increase a fluid temperature.

9. The laminating device of claim 1 wherein the roller head is shaped to form a gap from a bottom portion of the roller head to a flat portion of the substrate.

10. The laminating device of claim 1 wherein the roller head comprises a top portion and a bottom portion mechanically coupled to the top portion to form a variable gap.

11. The laminating device of claim 1 wherein the driver comprises a sensor system including a temperature sensor and a pressure sensor.

12. The laminating device of claim 1 wherein the driver comprises a circuit to provide a radio-frequency (RF) energy as the bonding energy.

13. The laminating device of claim 12 wherein the circuit comprises an RF source, the coupler, the roller head, and a ground coupling the substrate to the RF source.

14. The laminating device of claim 1 wherein the roller head comprises a flexible membrane containing a hot fluid.

15. A roller head for use in a laminating device to bond a protective layer to a substrate, comprising:
a body having a compliant contour to fit a substrate feature; wherein
the body is adapted to transmit a bonding energy to an adhesive layer on a top surface of the substrate at a localized contact point at a pre-selected temperature, and pressure, and for a pre-selected dwell time.

16. The roller head of claim 15 wherein the body comprises a compliant foam.

17. The roller head of claim 15 further comprising a material selected from a group consisting of an electrically conductive material and a thermally conductive material.

18. A method for bonding a protective layer to a substrate, the method comprising:
placing a protective layer over a substrate;
rotating a roller head;
placing the rotating roller head proximal to the protective layer;
providing a bonding energy to an adhesive layer on the substrate through the protective layer; and
displacing the roller head along a trajectory in a top surface of the substrate.

19. The method of claim 18 wherein providing the bonding energy comprises at least one of the group consisting of providing a heat transferred from a hot fluid, and providing a radio-frequency (RF) energy transferred from an alternate current (AC) circuit.

20. The method of claim 18 further comprising allowing the roller head to deform in compliance with a substrate profile.
